(19) United States
(12) Patent Application Publication
(10) Pub. No.: US 2015/0379749 A1
(43) Pub. Date: Dec. 31, 2015

(54) OBJECT DISPLAY CONTROL APPARATUS, OBJECT DISPLAY CONTROL METHOD, AND STORAGE MEDIUM STORING OBJECT DISPLAY CONTROL PROGRAM

(71) Applicant: CASIO COMPUTER CO., LTD., Tokyo (JP)

(72) Inventor: Kota ENDO, Hachioji-shi (JP)

(73) Assignee: CASIO COMPUTER CO., LTD., Tokyo (JP)

(21) Appl. No.: 14/748,994

(22) Filed: Jun. 24, 2015

(30) Foreign Application Priority Data
Jun. 30, 2014 (JP) 2014-135108

(51) Int. Cl. G06T 11/60; G06T 11/20

(52) U.S. Cl. CPC G06T 11/60; G06T 11/20

(57) ABSTRACT

According to one embodiment, an object display control apparatus includes a display and a processor. The processor executes a process of displaying on the display at least one object comprising a plurality of object parts, wherein the plurality of object parts include first object parts having variable values; setting one of the first object parts displayed on the display as a change target for changing the value of the one of the first object parts; and displaying a list of the first object parts, the one of the first object parts set as the change target being distinguishably displayed from the other of the first object parts in the list.

### CROSS-REFERENCE TO RELATED APPLICATIONS

This application is based upon and claims the benefit of priority from Japanese Patent Application No. 2014-135108, filed Jun. 30, 2014, the entire contents of which are incorporated herein by reference.

### BACKGROUND OF THE INVENTION

1. Field of the Invention

The present invention relates to an object display control apparatus and an object display control method which are suited to display an arbitrary geometric object.

2. Description of the Related Art

In conventional object display apparatuses, it is thought that a part of an arbitrarily displayed geometric object is easily designated and selected, and the length or degree of a side or an angle, which is the selected object part, is measured, and the measured value is displayed (e.g. Jpn. Pat. Appln. KOKAI Publication No. 2012-14440).

In the conventional object display apparatuses, a side or an angle, which is a part of a geometric object, can be designated as a measurement target, the length of the designated side or the degree of the designated angle can be measured, and the measured value can be displayed.

However, it is not possible to alter the geometric object while successively varying the length of the designated side or the degree of the designated angle by a simple operation.

Even if a part of the object is designated as a measurement target and the object is altered by varying the length or degree by inputting a new numerical value to the length or degree of the designated object part, other object parts also vary in accordance with the alteration of the designated object part. Thus, if the altered object part and the other object parts, which vary in accordance with the alteration of the altered object part, are difficult to understand, such a problem will arise that it is difficult to estimate how the object as a whole will vary.

The present invention has been made in consideration of the above circumstances, and the object of the invention is to provide an object display control apparatus and an object display control method which enable easily understandable display of an object part, which is set as a target of alteration by the user, and other object parts which vary in accordance with the alteration of this object part.

### BRIEF SUMMARY OF THE INVENTION

In general, according to one embodiment, an object display control apparatus includes a display and a processor. The processor executes a process of displaying on the display at least one object comprising a plurality of object parts, wherein the plurality of object parts include first object parts having variable values; setting one of the first object parts displayed on the display as a change target for changing the value of the one of the first object parts; and displaying a list of the first object parts, the one of the first object parts set as the change target being distinguishably displayed from the other of the first object parts in the list.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a front view illustrating an external appearance structure of a graph/geometric object scientific calculator 10 according to an embodiment of an object display control apparatus of the present invention.

FIG. 2 is a block diagram illustrating a circuit configuration of the graph/geometric object scientific calculator 10.

FIG. 3 is a flowchart illustrating an object display control process which is executed by an object mode of the graph/geometric object scientific calculator 10.

FIG. 4A and FIG. 4B are flowcharts illustrating a slider-settable object part display process which is involved in the object display control process executed by the object mode of the graph/geometric object scientific calculator 10, FIG. 4A being a flowchart illustrating an object part display process (A) of a first embodiment, and FIG. 4B being a flowchart illustrating an object part display process (B) of a second embodiment.

FIG. 5A to FIG. 5E are views illustrating a display operation of the first embodiment, which corresponds to a user operation based on the object display control process executed by the object mode of the graph/geometric object scientific calculator 10.

FIG. 6A to FIG. 6F are views illustrating a display operation (part 1) of the second embodiment, which corresponds to a user operation based on the object display control process executed by the object mode of the graph/geometric object scientific calculator 10.

FIG. 7A to FIG. 7F are views illustrating the display operation (part 2) of the second embodiment, which corresponds to a user operation based on the object display control process executed by the object mode of the graph/geometric object scientific calculator 10.

FIG. 8A to FIG. 8F are views illustrating the display operation (part 3) of the second embodiment, which corresponds to a user operation based on the object display control process executed by the object mode of the graph/geometric object scientific calculator 10.

### DETAILED DESCRIPTION OF THE INVENTION

Embodiments of the present invention will be described hereinafter with reference to the accompanying drawings.

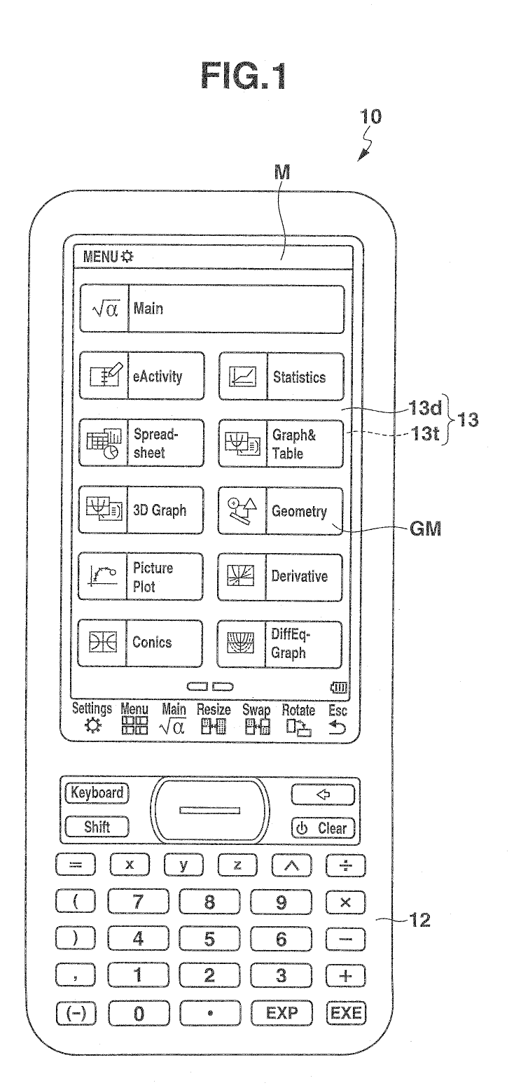

FIG. 1 is a front view illustrating an external appearance structure of a graph/geometric object scientific calculator 10 according to an embodiment of an object display control apparatus of the present invention.

This object display control apparatus is implemented as a purpose-specific graph/geometric object scientific calculator 10 which is to be described below, or is constructed as a tablet terminal, a mobile phone, a portable game console, or the like, which includes an object display function.

This graph/geometric object scientific calculator 10 includes a function of displaying an input function expression and a graph image corresponding to this function expression, and a function of displaying a geometric object which is input.

On the main body of this graph/geometric object scientific calculator 10, a key input unit 12 is provided in a range of approximately a lower half of a front surface of the main body, and a touch panel display 13 is provided in a range of approximately an upper half of the front surface.

The key input unit 12 is equipped with numerical value/sign keys, function/operator keys, and a cursor key.

The numerical value/sign keys are composed of an input key group of numerical values/signs, in which various numerical keys and sign keys are arranged.

The function/operator keys are composed of various function sign keys which are operated at a time of inputting an arithmetic expression or a function expression, and operator keys such as [+], [−], [×], [÷], and [=].

The touch panel display 13 is configured such that a transparent touch panel 13t is laid over a liquid crystal display screen 13d which is capable of effecting color display.

In this graph/geometric object scientific calculator 10, a main menu M is displayed in accordance with a touch operation of a menu button [Menu] which is displayed along an upper end of the touch panel display 13. By selectively touch-operating various icons displayed on this main menu M, a transition occurs to an operation mode of a function corresponding to the touched icon.

In this embodiment, a description is given of an operation mode (object mode) of an object display function which is started by a [Geometry] icon GM.

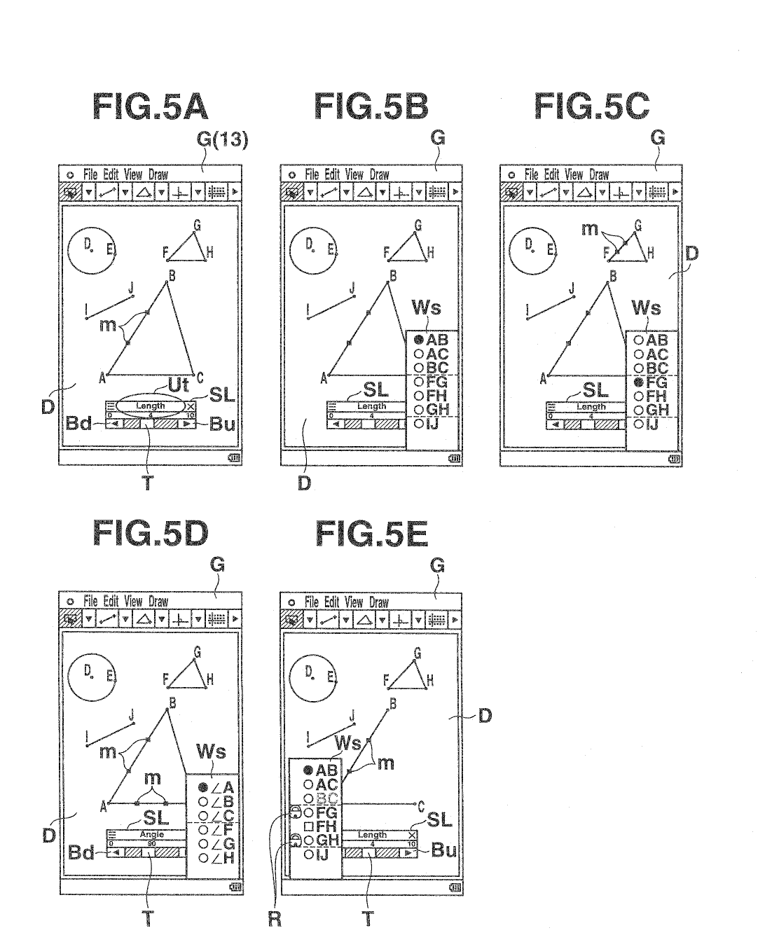

This object mode includes a function of drawing, for example, as illustrated in. FIG. 5E (to be described later), arbitrary geometric objects (in this example, a triangle (ABC), a circle (E: center D), a triangle (FGH), and a straight line (IJ)) on an object drawing area D which is opened by a drawing [Draw] function of a geometric object screen G; a function of selecting an object part (a side (AB) of the triangle (ABC)) of a drawn object, adding a selection mark m to the selected object part, and distinguishably displaying this object part with a thick line; a function of displaying a slider (operation display element) SL [Length] which alters a numerical value (here, the length of side (AB)) of the selected object part (side (AB)) in accordance with a user operation; a function of altering the numerical value of the object part by an operation of a tab T of the slider SL [Length] or an increase/decrease button Bu, Bd, and altering and displaying the object; a function of locking (“lock”) or unlocking (“lock-off”) the numerical value of an arbitrary object part; and a function of displaying an object parts list window Ws in which object parts of objects drawn on the object drawing area D are listed by signs of these object parts.

In this object parts list window Ws (case of FIG. 5E), an object part, which is set as a target of numerical value alteration by the slider SL, among the listed object parts of the respective objects, is distinguishably displayed by a black circle “”. Object parts, which are selectable as targets of numerical value alteration, are distinguishably displayed by a white circle “∘”. Object parts with values, which are fixed (locked), are distinguishably displayed by a lock-on icon R, and an object part, which is unselectable as a target of alteration, is distinguishably displayed by pale-color characters.

Incidentally, in the object parts list window Ws in FIG. 5E, since the object part (side (BC)) of the triangle (ABC) is not displayed, the object part (side (BC)) is distinguishably displayed by pale-color characters as an unselectable object part as a target of numerical value alteration. In addition, an object part (side (FH)) of the triangle (FGH) is distinguishably displayed by a pale-color sign “□” as an unselectable object part as a target of numerical value alteration, since the numerical values (lengths) of the other two sides (FG) and (GH) are fixed (locked).

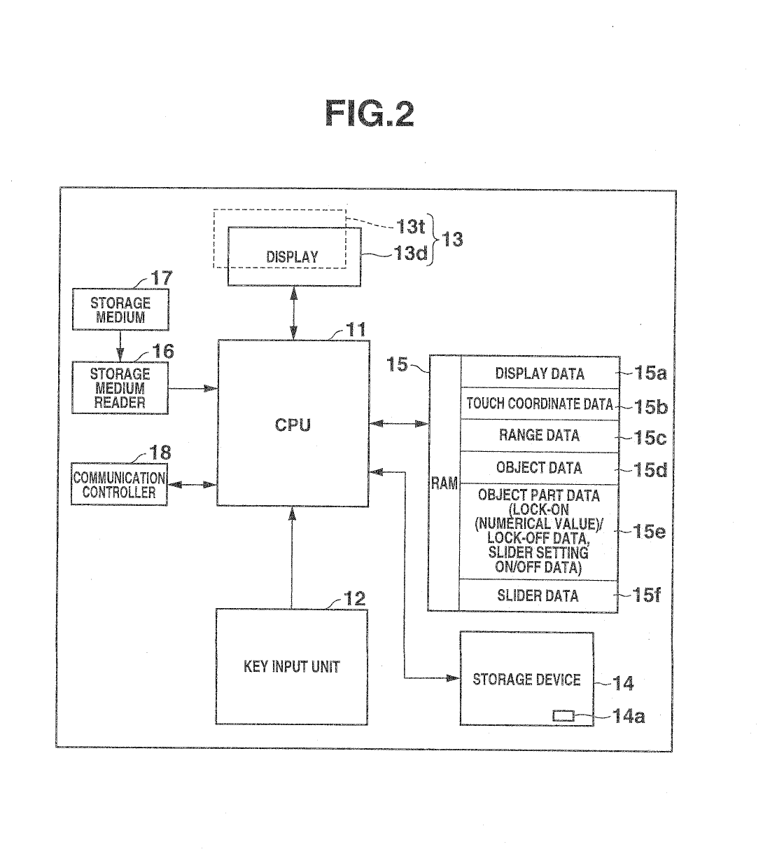

FIG. 2 is a block diagram illustrating a circuit configuration of the graph/geometric object scientific calculator 10.

The graph/geometric object scientific calculator 10 includes a CPU 11 which is a microcomputer.

In accordance with an electronic calculator control program 14a that is prestored in a storage device 14 such as a flash ROM, or an electronic calculator control program 14a which has been read in the storage device 14 from an external storage medium 17 such as a memory card via a storage medium reader 16, or an electronic calculator control program 14a which has been downloaded in the storage device 14 via a communication controller 18 from a Web server (program server) on a communication network (Internet), the CPU 11 controls the operations of the respective circuit components by using a RAM 15 as a working memory, and executes various functions provided in the graph/geometric object scientific calculator 10, such as an electronic calculator function, a function graph rendering function, and an object drawing function.

The storage device 14, RAM 15, storage medium reader 16 and communication controller 18, in addition to the key input unit 12 and touch panel display 13 shown in FIG. 1, are connected to the CPU 11.

The RAM 15 stores various data which are necessary for the processing operations of the CPU 11. The RAM 15 is provided with a display data storage area 15a on which data that is color-displayed on the screen of the touch panel display 13 is developed, and is also provided with a touch coordinate data storage area 15b, a range data storage area 15c, an object data storage area 15d, an object part data storage area 15e, and a slider data storage area 15f.

In the touch coordinate data storage area 15b, coordinate data of a touch position corresponding to a user operation, which was detected by the touch panel display 13, is stored.

In the range data storage area 15c, an X coordinate range (Xmin˜Xmax) and a Y coordinate range (Ymin˜Ymax), which indicate a display range of a graph that is set on a graph rendering area of the touch panel display 13 in the graph mode, are stored.

In the object data storage area 15d, the data of a geometric object, which was drawn on the object drawing area D, is stored as a combination of parts which constitute the geometric object.

In the object part data storage area 15e, data for generating the object parts list window Ws (see FIG. 5E) is stored. The object part data storage area 15e stores, with respect to each object part of each geometric object displayed on the object drawing area D, numerical value data of the object part (length, angle, supplementary angle, inclination, inclination angle, distance, radius, circumference, area, etc.), lock-on/lock-off data indicating whether the numerical value data is fixed or not, and slider setting ON/OFF data indicating whether an object part is set as a target of numerical value alteration by the slider SL.

In the slider data storage area 15f, data relating to the pattern of the sliders SL, which is an operation display element for altering the numerical value of an object part stored in the object part data storage area 15e in accordance with a user operation, is stored together with data relating to the shape and color of the slider SL, the number of variable steps by the tab T, and data relating to the number of variable steps by the right/left (increase/decrease) button Bu, Bd. In addition, the slider data storage area 15f stores a variable minimum value (Min), a variable maximum value (Max) and a current value (Current) relating to the numerical value of the object part of the slider SL, which is displayed based on the pattern of the slier SL, a unit variation amount (Dot) by the tab T, and a unit variation amount (Step) by the right/left (increase/decrease) button Bu, Bd.

In the meantime, the unit variation amount (Step) by the right/left (increase/decrease) button Bu, Bd is a numerical value variation amount of an increase or a decrease corresponding to a single touch (click) on the right (increase) button [→] Bu or left (decrease) button [←] Bd. Aside from this, the variation amount (Dot) by the tab T is a numerical value variation amount corresponding to a movement width of one display dot in a movement range (minimum value (Min)˜maximum value (Max)) of the tab T.

Here, the unit variation amount (Step) corresponding to a single touch (click) on the right (increase) button [Θ] Bu or left (decrease) button [←] Bd of the slider SL is defined as “step unit”, and the unit variation amount (Dot) corresponding to the movement width of one display dot in the movable range of the tab T of the slider SL is defined as “dot unit”.

In the graph/geometric object scientific calculator 10 with the above-described structure, the CPU 11 controls the operations of the respective circuit components in accordance with various processing instructions described in the above-described electronic calculator control program 14a, and the hardware and the software cooperate to realize various functions which will be described in the operational description below.

Next, the operation of the graph/geometric object scientific calculator 10 with the above-described structure is described.

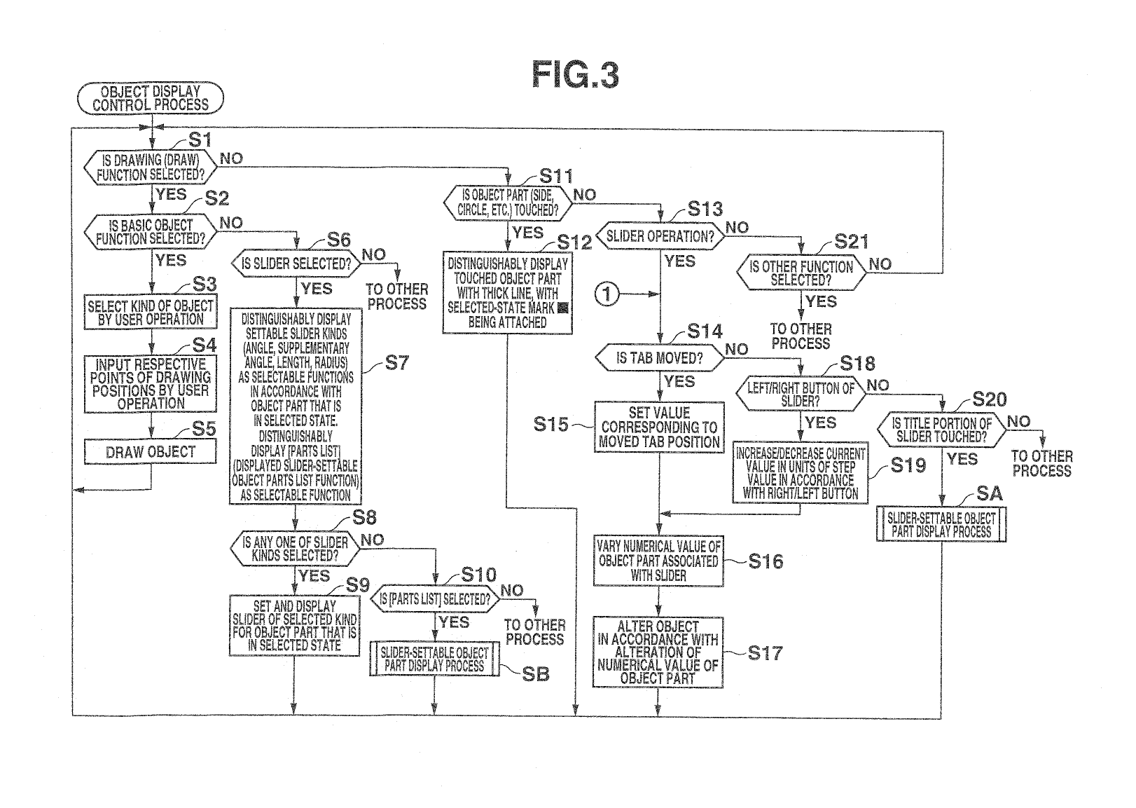

FIG. 3 is a flowchart illustrating an object display control process which is executed by the object mode of the graph/geometric object scientific calculator 10.

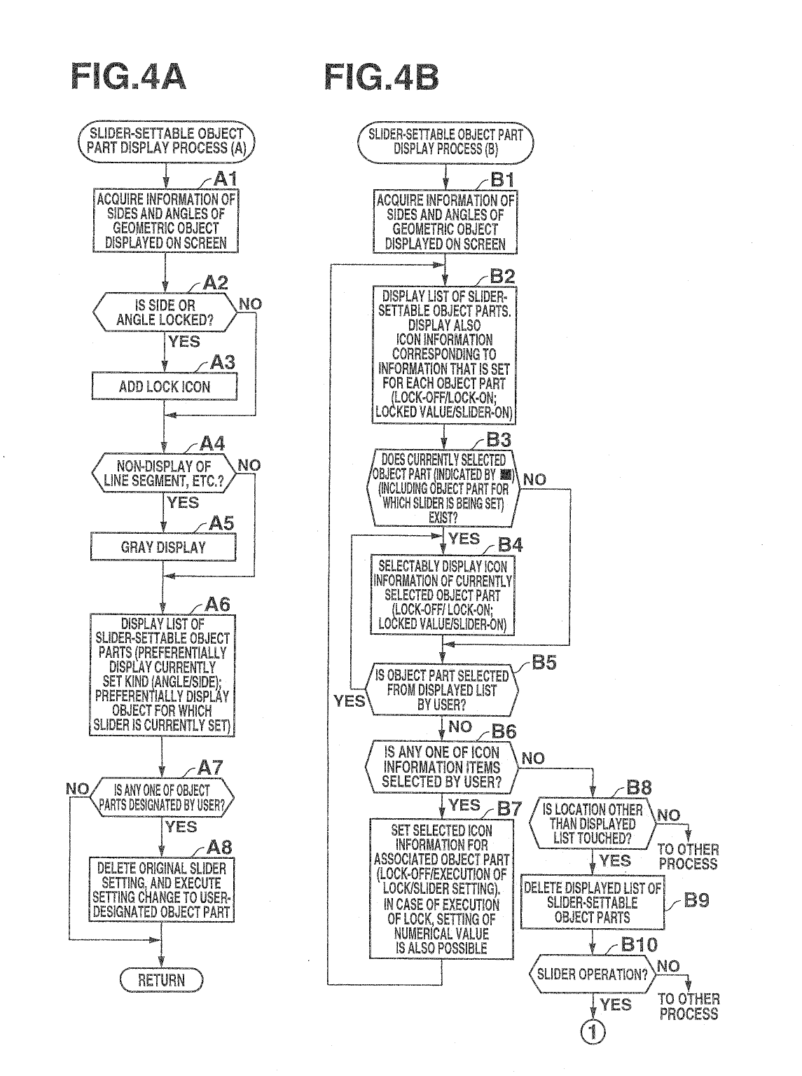

FIG. 4A and FIG. 4B are flowcharts illustrating a slider-settable object part display process which is involved in the object display control process executed by the object mode of the graph/geometric object scientific calculator 10. FIG. 4A is a flowchart illustrating an object part display process (A) of a first embodiment, and FIG. 4B is a flowchart illustrating an object part display process (B) of a second embodiment.

### First Embodiment

FIG. 5A to FIG. 5E are views illustrating a display operation of a first embodiment, which corresponds to a user operation based on the object display control process executed by the object mode of the graph/geometric object scientific calculator 10.

As illustrated in FIG. 1, if the [Geometry] icon GM is touch-operated from the main menu M displayed on the touch panel display 13 and the object mode is set, an object display control process illustrated in FIG. 3 is started.

On the geometric object screen G of the touch panel display 13 on which this object display control process was started, if a drawing [Draw] function (see FIG. GB) is selected (step S1 (Yes)) in accordance with a user operation, and a basic object (Basic Object) function is selected (step S2 (Yes)) and furthermore the kind of object is selected (step S3), an object drawing area D is displayed, on which an object of the selected kind (in this example, a triangle, a circle, a straight line) can be drawn.

On this object drawing area D, if vertices A, B and C, or vertices F, G and H, which correspond to a triangle that is arbitrarily chosen by a user, are pen-touched and input (step S4), a triangle (ABC) or a triangle (FGH) corresponding to the respective input vertices is drawn and displayed (step S5).

Similarly, if a center point D corresponding to a circle, which is arbitrarily chosen by the user, and a radius E thereof are pen-touched and input (step S4), a circle (E) corresponding to the respective input points is drawn and displayed (step S5).

Likewise, if one end point I and the other end point J corresponding to a straight line, which is arbitrarily chosen by the user, are pen-touched and input (step S4), a straight (IJ) corresponding to the two input points is drawn and displayed (step S5).

As regards the triangle (ABC), in order to alter the length of a side (AB) thereof, if the side (AB) that is an object part is pen-touched and selected (step S11 (Yes)), the kind of line of this selected side (AB) is changed to a thick line and the side (AB) is distinguishably displayed, with selection marks m being added to the side (AB) (step S12).

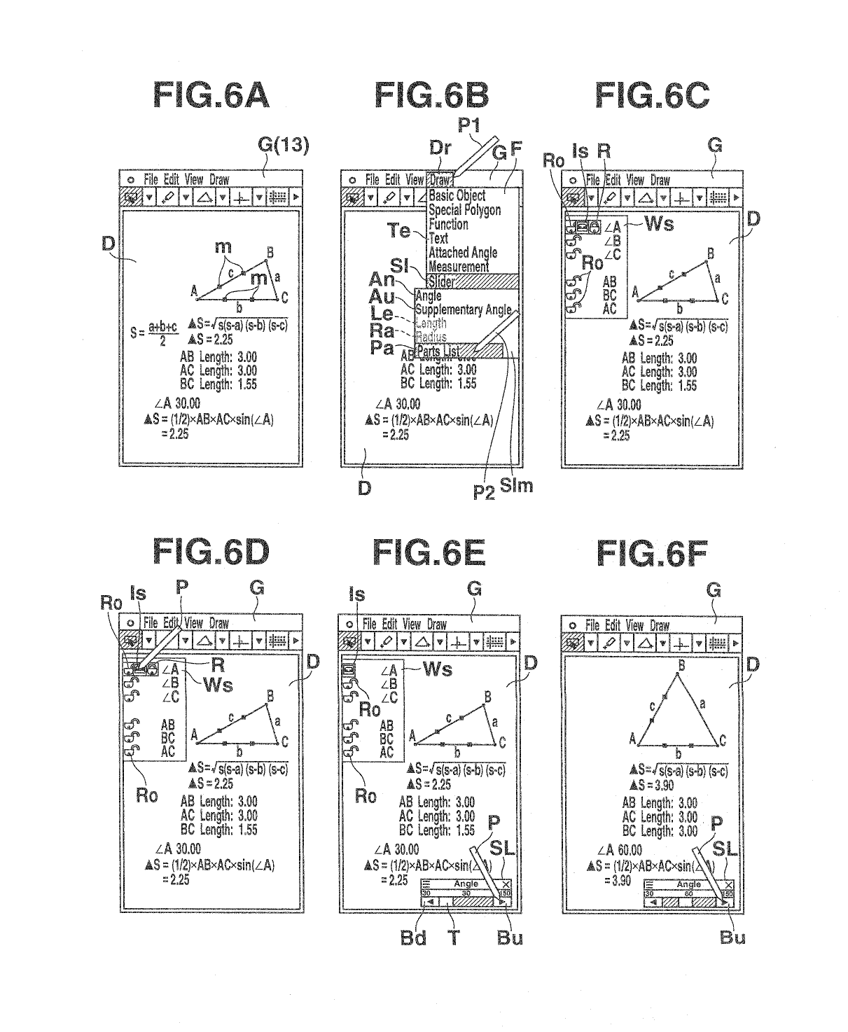

Here, in the state in which the side (AB) of the triangle (ABC) displayed on the object drawing area D is selected as the object part, the drawing [Draw] function (see FIG. 6B) is selected in accordance with a user operation P1 and thereby a drawing function list F is displayed in a pull-down form (step S1 (Yes)), and a setting item [Slider] S1 of a slider is selected in the drawing function list F (step S6 (Yes)).

Then, in a slider selection menu Slm which is further displayed in a pull-down form from the setting item [Slider] S1 of the slider, in accordance with the object part that is in the selected state, the kinds (angle [Angle] An, supplementary angle [Supplementary Angle] Su, length [Length] Le, radius [Radius] Ra), with respect to which numerical value alteration can be made by the slider SL for the selected object part, are distinguishably displayed to as to be selectable. In addition, a selection item [Parts list] Pa of an object parts list function for displaying a list window Ws of object parts, which are displayed on the object drawing area D and of which numerical value alteration is possible, is distinguishably displayed (step S7).

Here, in the slider selection menu Slm, since the object part that is in the selected state is the side (AB), the length [Length] Le that is the kind, with respect to which numerical value alteration can be made for the object part (side (AB)), is displayed with dense-color characters which indicate that this kind is selectable. The angle [Angle] An, supplementary angle [Supplementary Angle] Su and radius [Radius] Ra) that are the kinds, with respect to which numerical value alteration cannot be made, are displayed with pale-color characters which indicate that these are unselectable. In addition, the selection item [Parts list] Pa of the object parts list function is displayed with dense-color characters indicating that this is selectable.

Then, if the length [Length] Le that is the kind, with respect to which numerical value alteration can be made, is pen-touched and selected in the slider selection menu Slm (step S8 (Yes)), the object part (side (AB)) in the selected state is set as an alteration target for altering the value of the length thereof, as illustrated in FIG. 5A, and the slider SL [Length] for varying the value of the length is displayed on a free area of the object drawing area D (step S9).

In the object drawing area D on which the slider SL [Length] is displayed, a title portion Ut of the slider SL [Length] is touched when it is desired to confirm, with respect to each object part of each object, whether the slider is displayed and set for the object part as the target of numerical value alteration, whether the object part is selectable as a target of numerical value alteration, and whether the numerical value is fixed (locked) or not (step S20 (Yes)). Then, a transition occurs to a slider-settable object part display process (A) of the first embodiment which is illustrated in FIG. 4A and, as illustrated in FIG. 5B, an object parts list window Ws is generated and displayed (step SA).

In this slider-settable object part display process (A), with respect to each of the object parts constituting each object displayed on the object drawing area D, the following data are acquired from the object part data storage area 15e: numerical value data of each object part (length, angle, supplementary angle, inclination, inclination angle, distance, radius, circumference, area, etc.); lock-on/lock-off data indicating whether the numerical value data is fixed or not; and slider setting ON/OFF data indicating whether the slider is displayed and set for the object part as the target of numerical value alteration by the slider SL (step A1).

Here, a lock-on icon R is added to an object part with numerical data which is locked on (fixed) (step A2 (Yes)→A3).

In addition, an object part, one end point and the other end point of which exist but a line segment, etc. of which is not displayed and cannot be set as a target of numerical value alteration, is set with pale-color characters (gray display) (step A4 (Yes)→A5).

Then, as illustrated in FIG. 5B, the object parts list window Ws, which indicates the setting state of numerical value alteration of each object part by the slider SL, is generated and displayed (step A6).

In the object parts list window Ws illustrated in FIG. 5B, the object part (side (AB)) in the selected state is distinguishably displayed by a black circle “” as an object part that is set as a target of numerical value alteration by the slider SL [Length]. The other object parts (sides (AC), (BC), (FG), (FH), (GH) and (IJ)) are distinguishably displayed by white circles “∘” as object parts that are selectable as the target of numerical value alteration.

Incidentally, in the object parts list window Ws, object parts corresponding to the kind of numerical value alteration (in this case, “Length” since the object part in the selected state is the side (AB)), which corresponds to the object part which is currently in the selected state, are preferentially displayed. In addition, the object parts of the object, which includes the object part in the selected state, are preferentially displayed.

Specifically, in the object parts list window Ws, the sides (AB), (AC), (BC), . . . , (IJ) of the respective objects are displayed, with priority being placed on the object part (side (AB)) of the object (triangle (ABC)) that is in the selected state. In addition, the angles (∠A), (∠B), . . . , (∠H) of the respective objects are also displayed in a list form by scroll of the window Ws.

In the object parts list window Ws in FIG. 5B, if the object part “∘ FG” of the triangle (FGH), which is distinguishably displayed so as to be selectable as a target of numerical value alteration, is pen-touched and designated (step A7 (Yes)), the setting of the object part (side (AB)), which has been set as the original target of numerical value alteration by the slider SL, is released, as illustrated in FIG. 5C, and the object part (side (FG)) designated this time is set as a target of numerical value alteration and is distinguishably displayed by a black circle “”. In addition, selection marks m are added to the side (FG) of the triangle (FGH) and the side (FG) is distinguishably displayed (step A8).

In addition, as illustrated in FIG. 5D, the angle (∠A) formed between the object parts (side (AB) and side (AC)) of the triangle (ABC) is pen-touched and set in the selected state (step S11, S12). In the same manner as described above, the drawing [Draw] function (see FIG. 6B) is selected, and thereby the drawing function list F is displayed (step S1 (Yes)). From the drawing function list F, the setting item [Slider] S1 of the slider is selected (step S6 (Yes)). Further, from the slider selection menu Slm displayed in a pull-down form (step S7), if the angle [Angle] An, with which numerical value alteration is possible for the object part (angle (∠A)) that is in the selected state, is selected (step S8 (Yes)), a slider SL [Angle] for altering the angle of the object part (angle ∠A)) is displayed, and this object part is set as a target of numerical value alteration (step S9).

Here, if a title portion [Angle] of the slider SL [Angle] is touched (step S20 (Yes)), an object parts list window Ws is generated and displayed in the same manner as described above in accordance with the slider-settable object part display process (A) of the first embodiment, which is illustrated in FIG. 4A (step SA (A1 to A6)). In this object parts list window Ws, the object part (angle (∠A)) is distinguishably displayed by a black circle “” as an object part that is set as a target of numerical value alteration by the slider SL [Angle], and the other object parts (angles (∠8), (∠C), (∠F), (∠G), (∠H) are distinguishably displayed by white circles “∘” as object parts that are selectable as the target of numerical value alteration.

Here, if the tab T of the slider SL [Angle] is pen-touched and moved (step S13, S14 (Yes)), a numerical value corresponding to the moved position is set, based on a dot-unit variation amount (Dot) which corresponds to the movement of the tab T (step S15). The numerical value of the (angle (∠A)) is altered to this set numerical value (step S16).

Then, in accordance with the numerical value alteration of the (angle (∠A)), the object part in the selected state (the angle (∠A) formed between the side (AB) and side (AC)) is varied, and the triangle (ABC) is altered and displayed (step S17).

Further, if the left (decrease) button Bd or right (increase) button Bu of the slider SL [Angle] is pen-touched (step S13, S18 (Yes)), a numerical value that is increased/decreased based on a step-unit variation amount (Step), which corresponds to the touch operation of the left/right (decrease/increase) button Bd, Bu, is set (step S19), and the numerical value of the (angle (∠A)) is altered to this set numerical value (step S16).

Then, in accordance with the numerical value alteration of the (angle (∠A), the object part in the selected state (the angle (∠A) is varied, and the triangle (ABC) is altered and displayed (step S17).

On the other hand, as illustrated in FIG. 5A or 5B, in the state in which the object part (side (AB)) of the triangle (ABC) is selected and in the state in which the length of the object part (side (AB)) can be altered by the slider SL [Length], the side (BC) of the triangle (ABC) is deleted, as illustrated in FIG. 5E, and the numerical values (lengths) of two sides (FG) and (GH) of the triangle (FGH) are locked.

Here, if the title portion [Length] of the slider SL [Length] is touched (step S20 (Yes)), an object parts list window Ws is generated and displayed in the same manner as described above in accordance with the slider-settable object part display process (A) of the first embodiment, which is illustrated in FIG. 4A (step SA (A1 to A6)). In this object parts list window Ws, the object part (side (AB)), which is set as a target of numerical value alteration by the slider SL [Length], is distinguishably displayed by a black circle “”, object parts (sides (AC), (FG), (GH), (IJ)), which are selectable as the target of numerical value alteration, are distinguishably displayed by white circles “∘”, object parts (sides (FG), (GH)) with numerical values, which are fixed (locked), are distinguishably displayed by lock-on icons R, and an object part (side (BC)), which is unselectable as the target of numerical value alteration, is distinguishably displayed by pale-color characters (gray display).

Thus, according to the slider-settable object part display process (A) of the first embodiment, which is involved in the object display control process of the graph/geometric object scientific calculator 10 with the above-described structure, arbitrary geometric objects (triangles (ABC) and (FGH), circle (E), straight line (IJ)) are displayed on the object drawing area D. An object part (side (AB)) with a numerical value (length), which is to be varied, among the object parts constituting the respective geometric objects, is selected, and the slider SL [Length] for altering the numerical value (length) is displayed. Then, the numerical value (length) of the selected object part (side (AB)) is altered in accordance with a user operation of the slider SL [Length], and the geometric object (triangle (ABC)) including this object part is altered and displayed. In this case, if the title portion [Length] Ut of the slider SL is touched, the object parts list window Ws is generated and displayed. In the object parts list window Ws, the object parts (sides (AB), (AC), . . . , (IJ)) of each geometric object are listed. Of the respective object parts, the object part, which is set as a target of numerical value alteration by the slider SL, is distinguishably displayed by the black circle “”, object parts, which are selectable as the target of numerical value alteration, are distinguishably displayed by the white circles “∘”, object parts with numerical values, which are (fixed) locked, are distinguishably displayed by the lock-on icons R, and an object part, which is unselectable as the target of numerical value alteration, is distinguishably displayed by pale-color characters (sign).

Thereby, an object part which is designated by the user and of which numerical value alteration is made, and the other object parts, which vary in accordance with the alteration of this numerical value, can be easily understandably displayed. Therefore, an arbitrary geometric object can be displayed while easily estimating how the entirety of the geometric object including the object part, the numerical value of which is altered, varies.

In addition, according to the slider-settable object part display process (A) of the first embodiment, which is involved in the object display control process of the graph/geometric object scientific calculator 10 with the above-described structure, if the object part (side (FG)), which is distinguishably displayed by the white circles “∘” and is selectable as a target of numerical value alteration, is designated in the object parts list window Ws, the designated object part (side (FG)) is set as a target of numerical value alteration, the display of the designated object part (side (FG)) is changed to the distinguishable display by the black circle “”, and the setting of the side (FG) of the associated geometrical object (triangle (FGH)) is changed to the target of numerical value alteration by the slider SL. Then, in accordance with a user operation of the slider SL, the numerical value (length) of the object part (side (FG)), the setting of which was changed, is altered, and the geometric object (triangle (FGH)) including this object part is altered and displayed.

Thereby, an object part which is designated by the user and of which numerical value alteration is made, and the other object parts, which vary in accordance with the alteration of this numerical value, can be easily understandably displayed. Furthermore, the object part, which is to be set as the target of numerical value alteration, can easily be changed and set by the slider SL.

### Second Embodiment

FIG. 6A to FIG. 6F are views illustrating a display operation (part 1) of the second embodiment, which corresponds to a user operation based on the object display control process executed by the object mode of the graph/geometric object scientific calculator 10.

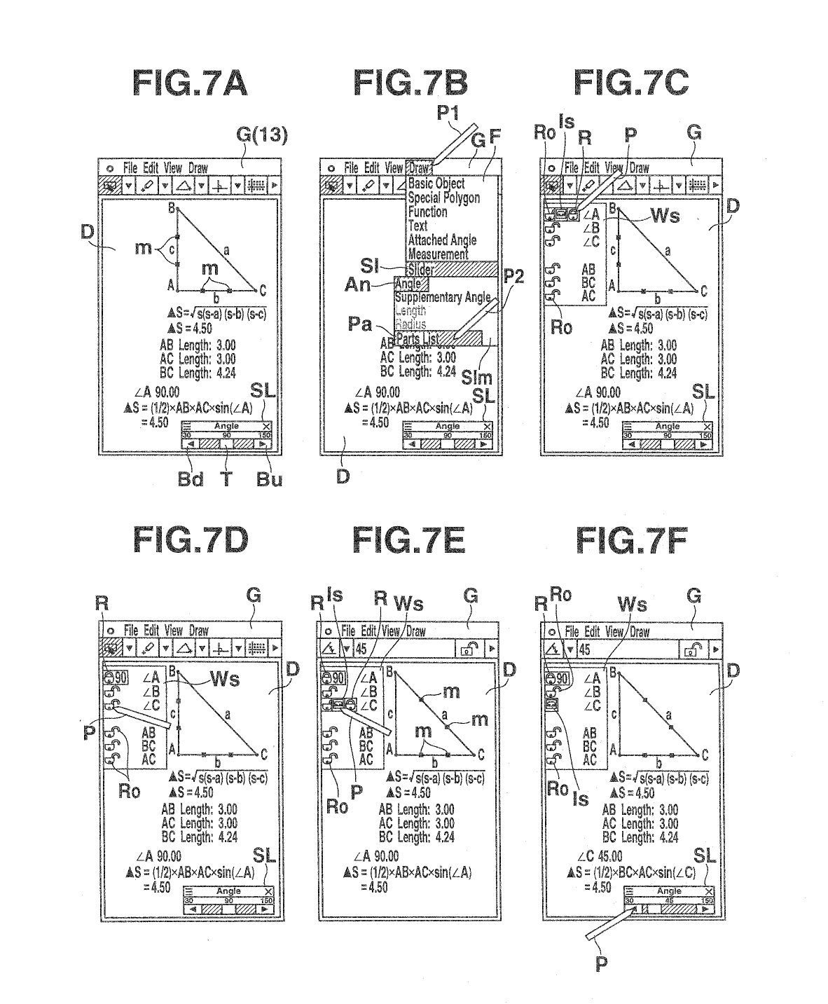

FIG. 7A to FIG. 7F are views illustrating the display operation (part 2) of the second embodiment, which corresponds to a user operation based on the object display control process executed by the object mode of the graph/geometric object scientific calculator 10.

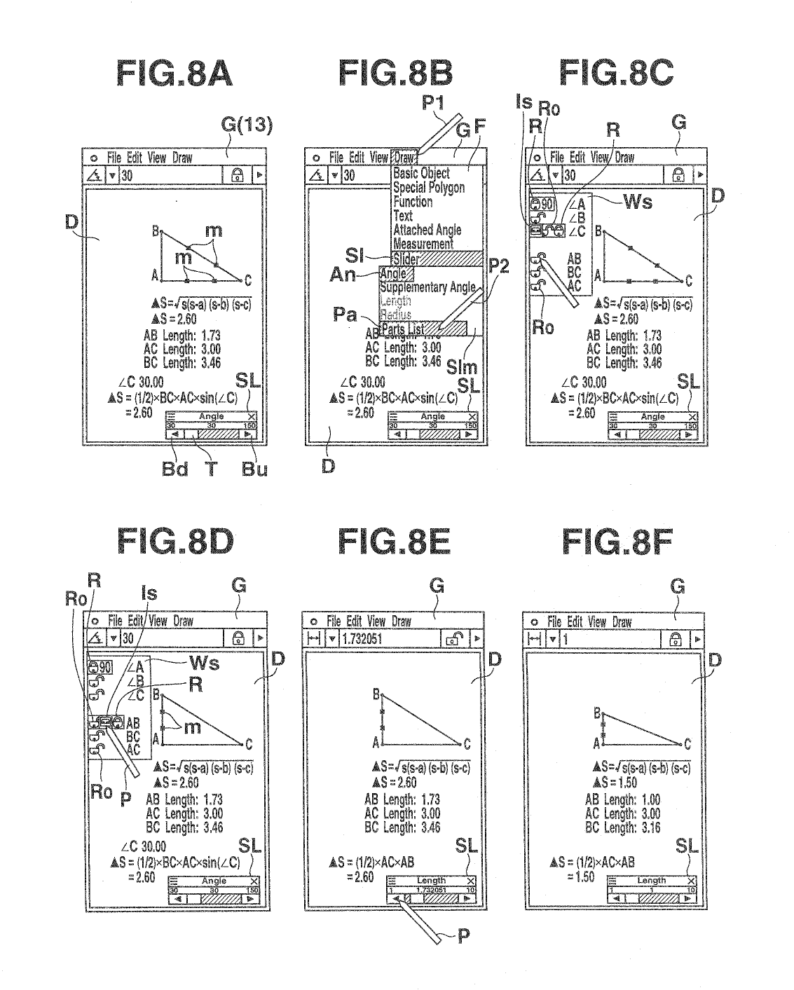

FIG. 8A to FIG. 8F are views illustrating the display operation (part 3) of the second embodiment, which corresponds to a user operation based on the object display control process executed by the object mode of the graph/geometric object scientific calculator 10.

In the display operation of the second embodiment, a description is given of a concrete example in a case in which, while the numerical value (the angle of a vertex or the length of a side) of an arbitrary object part of a geometric object (triangle (ABC)), which is displayed on the object drawing area D, is being varied, this geometric object is altered, and learning is done while verifying how an area S of the geometric object varies.

In accordance with the process of the above steps S1 to S5, as illustrated in FIG. 6A, an arbitrary geometric object (triangle (ABC)) is drawn and displayed on the object drawing area D. By touching object parts (side (AB) and side (AC)) of the geometric object, the respective sides (AB) and (AC) are distinguishably displayed with thick lines, with selection marks m being added thereto (step S11, S12).

Here, the drawing [Draw] function (see FIG. 6B) is selected in accordance with a user operation and thereby a drawing function list F is displayed in a pull-down form, and a setting item [Measurement] of a measurement function is selected in the drawing function list F. Then, the lengths “AB: 3.00”, “AC: 3.00” and “BC: 1.55” of the respective sides (AB), (AC) and (BC) of the triangle (ABC), and the angle “∠A 30.00”, which is formed between the sides (AB) and (AC) that are in the selected state, are measured and displayed. In addition, the area “▴S=2.25” of the triangle (ABC), which was measured based on Heron's formula, is displayed.

Here, a setting item [Text] Te of a text input function is selected from the drawing function list F, and an equation “▴S=(½)×AB×AC×sin(∠A)” for calculating and verifying the area S of the triangle (ABC) by the user himself/herself, and a calculation result “2.25” thereof are input and displayed (step S21 (Yes)).

Then, as illustrated in FIG. 6B, if the setting item [Slider] S1 of the slider is selected in the drawing function list F that was displayed in accordance with a user operation P1 (step S6 (Yes)), the slider selection menu Slm is further displayed in a pull-down form from the setting item [Slider]S1. In the slider selection menu Slm, in accordance with the object parts (sides (AB) and (AC)) that are in the selected state, the kinds (angle [Angle] An and supplementary angle [Supplementary Angle] Su), with respect to which numerical value alteration can be made by the slider SL for the selected object parts, are selectably and distinguishably displayed with dense-color characters. In addition, a selection item [Parts list] Pa of an object parts list function for displaying the list window Ws of object parts, which are displayed on the object drawing area D and of which numerical value alteration can be made, is distinguishably displayed with dense-color characters (step S7).

Then, if the selection item [Parts list] Pa of the object parts list function is selected by a pen touch P2 in the slider selection menu Slm (step S10 (Yes)), a transition occurs to a slider-settable object part display process (B) of the second embodiment, which is illustrated in FIG. 4B, and the object parts list window Ws is generated and displayed (step SB).

In this slider-settable object part display process (B), with respect to each of the object parts constituting the geometrical object (triangle (ABC)) displayed on the object drawing area D, the following data are acquired from the object part data storage area 15e: numerical value data of the object part (length, angle, supplementary angle, area, etc.), lock-on/lock-off data indicating whether the numerical value data is fixed or not, and the slider setting ON/OFF data indicating whether the object part is set as a target of numerical value alteration by the slider SL (step B1).

Then, based on the data of the respective object parts, which was obtained from the object part data storage area 15e, an object parts list window Ws, which indicates the setting state of numerical value alteration by the slider SL, is generated and displayed, as illustrated in FIG. 6C (step B2).

In this object parts list window Ws illustrated in FIG. 6C, the respective object parts (angles (∠A), (∠B) and (∠C), and sides (AB), (BC) and (AC)) of the triangle (ABC), for which the slider can be set (numerical value alteration can be made), are distinguishably displayed in a list form with dense-color characters. In addition, lock-off icons Ro, which indicate that the numerical values of the object parts are not fixed, are associated with the object parts and displayed.

Furthermore, a slider icon Is for setting the slider SL and a lock-on icon R for locking the numeral value are added and displayed so as to be selectable, in association with the object part (angle (∠A) formed between sides (AB) and (AC)) which is currently in the selected state, among the respective object parts displayed in the list form (step B3 (Yes)→B4).

Thereby, the user can confirm that numerical value alteration can be made for each of the object parts (angles (∠A), (∠B) and (∠C), and sides (AB), (BC) and (AC)) of the triangle (ABC). In addition, the user can confirm that, as regards the angle (∠A) formed between sides (AB) and (AC), the slider SL can immediately be set and the angle can be altered, and that the current angle can be locked.

Here, as illustrated in FIG. 6D, if the slider icon Is, which is associated with the object part (angle (∠A)) displayed in the object parts list window Ws, is selected by a pen-touch P (step B6 (Yes)), a slider SL [Angle] for altering the numerical value (angle) of the object part (angle (∠A)) is displayed, as illustrated in FIG. 6E, and the object part (angle (∠A)) is set as the target of numerical value alteration (step B7).

Then, the object parts list window Ws is updated. The selected slider icon Is is displayed at the object part (angle (∠A)) in the object parts list window Ws, and it is distinguishably displayed that the object part (angle (∠A)) was set as the target of numerical value alteration (step B2).

If the right (increase) button Bu of the slider SL [Angle] is touched by a pen touch P and it is determined that a location other than the object parts list window Ws was touched (step B8 (Yes)), the object parts list window Ws is deleted, as illustrated in FIG. 6F (step B9).

Then, in accordance with the determination of the operation of the right (increase) button Bu of the slider SL [Angle](step B10 (Yes)→S18 (Yes)), a numerical value “60”, which was increased based on the step-unit variation amount (Step) corresponding to the touch operation of the right button Bu, is set (step S19), and the numerical value of the (angle (∠A)) is altered to this set numerical value (step S16).

In accordance with this numerical value alteration (“30”→“60”) of the angle (∠A), the object part ((angle (∠A)) that is in the selected state is varied and the triangle (ABC) is altered and displayed (step S17).

At this time, the area, which was measured according to Heron's formula after the alteration to “60” of the numerical value of the object part ((angle (∠A)), is displayed as “▴S=3.90”, and it can be verified that the area is identical to the calculation result “3.90” of the user himself/herself.

Subsequently, if the right (increase) button Bu of the slider SL [Angle] is further touched by a pen touch P (step S13 (Yes)→S18 (Yes)), a numerical value “90”, which was increased in accordance with the operation of the right button Bu, is set, as illustrated in FIG. 7A, in the same manner as described above (step S19), and the numerical value of the (angle (∠A)) is altered (step S16).

Then, in accordance with this numerical value alteration (“60”→“90”) of the angle (∠A), the object part ((angle (∠A)) that is in the selected state is varied and the triangle (ABC) is altered and displayed (step S17).

In this case, similarly with the above, the area, which was measured according to Heron's formula after the alteration to “90” of the numerical value of the object part ((angle (∠A)), is displayed as “▴S=4.50”, and it can be verified that the area is identical to the calculation result “4.50” of the user himself/herself.

Thereafter, like the case illustrated in FIG. 6B, if the setting item [Slider] S1 of the slider is selected from the drawing function list F that was displayed in accordance with a user operation P1 (step S6 (Yes)), as illustrated in FIG. 7B, the slider selection menu Slm is further displayed in a pull-down form (step S7). If the selection item [Parts list] Pa of the object parts list function is selected by a pen touch P2 in the slider selection menu Slm (step S10 (Yes)), a transition occurs to the slider-settable object part display process (B) of the second embodiment, which is illustrated in FIG. 4B, and the same object parts list window Ws as described above is generated and displayed, as illustrated in FIG. 7C (step SB).

In this object parts list window Ws illustrated in FIG. 7C, the respective object parts (angles (∠A), (∠B) and (∠C), and sides (AB), (BC) and (AC)) of the triangle (ABC), for which the slider can be set (numerical value alteration can be made), are distinguishably displayed in a list form with dense-color characters. In addition, lock-off icons Ro, which indicate that the numerical values of the respective object parts are not locked, are associated with the object parts and displayed. Furthermore, a slider icon Is for setting the slider SL and a lock-on icon R for locking the numeral value are added and displayed so as to be selectable, in association with the object part (angle (∠A) formed between sides (AB) and (AC)) which is currently in the selected state, among the respective object parts displayed in the list form (steps B1 to B4).

Here, in the object parts list window Ws, if the lock-on icon R, which is associated with the object part (angle (∠A)) formed between sides (AB) and (AC)) that is in the selected state, is touched by a pen touch P (step B6 (Yes)), the numerical value “90” of the object part (angle (∠A)) is fixed (locked), as illustrated in FIG. 7D (step B7), and an object parts list window Ws, in which the lock-on icon R is displayed together with the numerical value “90” that was locked in association with this object part (angle (∠A)), is displayed (block B2).

Then, in the object parts list window Ws, if another object part (angle (∠C)), for which the slider can be set (numerical value alteration can be made), is touched by a pen touch P (step B5 (Yes)), a slider icon Is for setting the slider SL and a lock-on icon R for locking the numeral value are added and displayed so as to be selectable, in association with the object part (angle (∠C)) which was selected by the pen touch, as illustrated in FIG. 7E. In addition, sides (BC) and (AC), which form the object part (angle (∠C)), are set in the selected state and displayed (step B4).

Here, if the slider icon Is, which is associated with the object part (angle (∠C)) displayed in the object parts list window Ws, is selected by a pen-touch P (step B6 (Yes)), a slider SL [Angle] for altering the numerical value (angle) of the object part (angle (∠C)) is displayed, as illustrated in FIG. 7F, and the object part (angle (∠C)) is set as the target of numerical value alteration (step B7).

Then, the object parts list window Ws is updated. The selected slider icon Is is displayed at the object part (angle (∠C)) in the object parts list window Ws, and it is distinguishably displayed that the object part (angle (∠C)) was set as the target of numerical value alteration (step B2).

In this case, since the object part, which was set as the target of numerical value alteration, has been changed from the angle (∠A)) to the angle (∠C)) by the slider SL [Angle], the setting item [Text] Te of the text input function is selected from the drawing function list F, and the equation for calculating and verifying the area S of the triangle (ABC) by the user himself/herself is rewritten to “▴S=(½)×BC×AC×sin(∠C)”.

If the left (decrease) button Bd of the slider SL [Angle] is touched by a pen touch P and it is determined that a location other than the object parts list window Ws was touched (step B8 (Yes)), the object parts list window Ws is deleted, as illustrated in FIG. 8A (step B9).

Then, in accordance with the determination of the operation of the left button Bd of the slider SL [Angle](step B10 (Yes)→S18 (Yes)), a numerical value “30”, which was decreased in accordance with the touch operation of the left button Bd, is set (step S19), and the numerical value of the (angle (∠C)) is altered to this set numerical value (step S16).

In accordance with this numerical value alteration (“45”→“30”) of the angle (AC), the object part (angle (∠C)) that is in the selected state is varied, and the triangle (ABC) is altered and displayed (step S17).

At this time, the area, which was measured according to Heron's formula after the alteration to “30” of the numerical value of the object part (angle (∠C)), is displayed as “▴S=2.60”, and it can be verified that the area is identical to the calculation result “2.60” of the user himself/herself.

Thereafter, as illustrated in FIG. 8B, if the selection item [Parts list] Pa of the object parts list function is selected by a pen touch P2 from the drawing function list F and slider selection menu Slm displayed in accordance with a user operation P1 (step S6, S7, S10 (Yes)), the same object parts list window Ws as described above is generated and displayed, as illustrated in FIG. 8C, in accordance with the slider-settable object part display process (B) of the second embodiment, which is illustrated in FIG. 4B (step SB).

In this object parts list window Ws illustrated in FIG. 8C, since the slider SL [Angle] is set at the object part (angle (∠C)) that is currently in the selected state, the lock-off icon Ro and lock-on icon R are selectably displayed following the slider icon Is (steps B1 to B4).

Here, in the object parts list window Ws, if another object part (side (AB)), for which the slider can be set (numerical value alteration can be made), is touched by a pen touch P (step B5 (Yes)), the slider icon Is and the lock-on icon R are added and displayed to be selectable, in association with the object part (side (AB)) which was selected by the pen touch, as illustrated in FIG. 8D (step B4). In addition, the object part (side (AB)) of the displayed triangle (ABC) is set in the selected state and displayed.

Here, if the slider icon Is, which is associated with the object part (side (AB)) displayed in the object parts list window Ws, is selected by a pen-touch P (step B6 (Yes)), a slider SL [Length] for altering the numerical value (length) of the object part (side (AB)) is displayed, as illustrated in FIG. BE, and the object part (side (AB)) is set as the target of numerical value alteration (step B7).

In this case, since the object part, which was set as the target of numerical value alteration by the slider SL, has been changed from the angle (∠C)) to the side (AB), the setting item [Text] Te of the text input function is selected from the drawing function list F, and the equation for calculating and verifying the area S of the triangle (ABC) by the user himself/herself is rewritten to “▴S=(½)×AC×AB”.

Then, if the left (decrease) button Bd of the slider SL [Length] is touched by a pen touch P and it is determined that a location other than the object parts list window Ws was touched (step B8 (Yes)), the object parts list window Ws is deleted (step B9).

Then, as illustrated in FIG. 8F, in accordance with the determination of the operation of the left button Bd of the slider SL [Length](step B10 (Yes)→S18 (Yes)), a numerical value “1.00”, which was decreased in accordance with the touch operation of the left button Bd, is set (step S19), and the numerical value of the (side (AB)) is altered to this set numerical value (step S16).

In accordance with this numerical value alteration (“1.73”→“1.00”) of the (side (AB)), the object part (side (AB)) that is in the selected state is varied, and the triangle (ABC) is altered and displayed (step S17).

At this time, like the above, the area, which was measured according to Heron's formula after the alteration to “1.00” of the numerical value of the object part (side (AB)), is displayed as “▴S=1.50”, and it can be verified that the area is identical to the calculation result “1.50” of the user himself/herself.

Thus, according to the slider-settable object part display process (B) of the second embodiment, which is involved in the object display control process of the graph/geometric object scientific calculator 10 with the above-described structure, an arbitrary geometric object (triangle (ABC)) is displayed on the object drawing area D. If the selection item [Parts list] Pa of the object parts list function is selected in the slider selection menu Slm which was displayed in a pull-down form in accordance with the setting item [Slider]S1 of the slider of the drawing function list F, the respective object parts (angles (∠A), (∠B) and (∠C), and sides (AB), (BC) and (AC)) of the triangle (ABC), for which the slider can be set (numerical value alteration can be made), are distinguishably displayed in a list form with dense-color characters. In addition, the object parts list window Ws is displayed. In the object parts list window Ws, the slider icon Is is associated with an object part which is currently in the set state as a target of numerical value alteration by the slicer SL, among the respective object parts. The lock-on icon R is associated with an object part with a numerical value which is fixed (lock-on). The lock-off icon Ro is associated with an object part with a numerical value which is not fixed (lock-off).

Thereby, an object part with a numerical value, which is altered by a user operation of the slider SL, and the other object parts, which vary in accordance with the alteration of this numerical value, can be easily understandably displayed. Therefore, an arbitrary geometric object can be displayed while easily estimating how the entirety of the geometric object including the object part, the numerical value of which is altered, varies.

In addition, according to the slider-settable object part display process (B) of the second embodiment, which is involved in the object display control process of the graph/geometric object scientific calculator 10 with the above-described structure, if an object part, which is other than the object part that is currently in the set state as the target of numerical value alteration by the slicer SL, is newly selected, the slider icon Is is displayed in association with this newly selected object part. In addition, the numerical value of the associated object part of the geometric object can be varied by the slider SL, and the geometric object including this object part can be altered and displayed.

Thereby, an object part with a numerical value, which is altered by a user operation of the slider SL, and the other object parts, which vary in accordance with the alteration of this numerical value, can be easily understandably displayed. Furthermore, the object part, which is to be set as the target of numerical value alteration by the slider SL, can easily be changed and set.

In the meantime, in the configurations of the above-described embodiments, responding to a touch on the title portion of the slider SL, a transition occurs to the object part display process (A) of the first embodiment, which is illustrated in FIG. 4A, and the object parts list window Ws in the mode illustrated in FIG. 5 is displayed. In addition, responding to the selection of the selection item [Parts list] Pa of the object parts list function from the slider selection menu Slm displayed in the pull-down form in accordance with the setting item [Slider] SL of the slider of the drawing function list F, a transition occurs to the object part display process (B) of the second embodiment, which is illustrated in FIG. 4B, and the object parts list window Ws in the mode illustrated in FIG. 6 to FIG. 8 is displayed. However, it is possible to adopt such a configuration that the object part display processes (A) and (B) of the first and second embodiments are interchanged.

The methods of the respective processes by the object display control apparatus described in each of the embodiments, that is, the respective methods of the slider-settable object part display processes (A) and (B) illustrated in FIG. 4, can all be stored as computer-executable programs in a medium of an external storage device, such as a memory card (ROM card, RAM card, etc.), a magnetic disk (floppy disk, hard disk, etc.), an optical disc (CD-ROM, DVD, etc.), or a semiconductor memory, and can be distributed. In addition, the computer (controller) of the electronic device, which includes the display that is capable of user input, reads the program, which is stored in the medium of the external storage device, into the storage device, and the operation is controlled by this read-in program. Thereby, it is possible to realize the slider-settable object part display function, which has been described in each of the embodiments, and to execute the same processes by the above-described methods.

In addition, the data of the program for realizing each of the above-described methods can be transmitted on a communication network in the form of a program code, and the data of the program can be taken in the electronic device, which includes the display that is capable of user input, from a computer apparatus (program server) connected to this communication network, and stored in the storage device, thereby realizing the above-described slider-settable object part display function.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An object display control apparatus comprising a display and a processor, the processor being configured to execute a process of:
displaying on the display at least one object comprising a plurality of object parts, wherein the plurality of object parts include first object parts having variable values;
setting one of the first object parts displayed on the display as a change target for changing the value of the one of the first object parts; and
displaying a list of the first object parts, the one of the first object parts set as the change target being distinguishably displayed from the other of the first object parts in the list.

2. The object display control apparatus of claim 1, wherein the processor is configured to further execute a process of:
displaying a slider for changing the value of the first object part set as the change target; and
changing the value of the first object part of the change target in accordance with an operation of the slider by a user.

3. The object display control apparatus of claim 2, wherein the processor is configured to further execute a process of:
selecting an object part among the object parts displayed in the list in accordance with a user operation; and
setting the selected object part as a change target for change of the value.

4. The object display control apparatus of claim 3, wherein the processor is configured to further execute a process of:
changing the object part, which has been set as the change target, to the selected object part, and setting the selected object part as the change target.

5. The object display control apparatus of claim 3, wherein the processor is configured to further execute a process of:
setting the value of the selected object part as a fixed value;
displaying a list of the object parts which have the variable values, wherein the object parts displayed in the list include the object part the value of which has been set as the fixed value; and
additionally displaying in the list the object part, the value of which has been set as the fixed value, in a distinguishable manner.

6. The object display control apparatus of claim 2, wherein the processor is configured to further execute a process of:
varying, when the value of the first object part of the change target has been changed in accordance with the operation of the slider by the user, the object including the first object part of the change target, the value of which has been changed, and displaying the varied object.

7. A method of controlling a computer of an electronic device including a display, and causing the computer to display an object, the method comprising causing the computer to:
display on the display at least one object comprising a plurality of object parts, wherein the plurality of object parts include first object parts having variable values;
set one of the first object parts displayed on the display as a change target for changing the value of the one of the first object parts; and
display a list of the first object parts, the one of the first object parts set as the change target being distinguishably displayed from the other of the first object parts in the list.

8. A non-transitory computer readable storage medium having stored therein instructions for controlling a computer of an electronic device including a display, which when executed by the electronic device, cause the electronic device to:
display on the display at least one object comprising a plurality of object parts, wherein the plurality of object parts include first object parts having variable values;
set one of the first object parts displayed on the display as a change target for changing the value of the one of the first object parts; and
display a list of the first object parts, the one of the first object parts set as the change target being distinguishably displayed from the other of the first object parts in the list.
